(19) United States
(12) Patent Application Publication
(10) Pub. No.: US 2005/0162281 A1
(43) Pub. Date: Jul. 28, 2005

(54) Consumer unit

(76) Inventor: Stephen Capon, Barnstaple (GB)

Correspondence Address: Steven S. Payne;Suite 1005, 1101 17th Street, N.W., Washington, DC, 20036, US

(21) Appl. No.: 10/969,841

(22) Filed: Oct. 22, 2004

(30) Foreign Application Priority Data
Apr. 17, 2003 (WO) PCT/GB03/01661
Apr. 24, 2002 (GB) 0209388.8
Nov. 5, 2002 (GB) 0225715.2

(51) Int. Cl. G08B 21/00

(52) U.S. Cl. 340/635

(57) ABSTRACT

A consumer unit is provided comprising at least one current protection device. The unit is distinguished in that it further comprises at least one light associated with the unit, the at least one light being operatively connected to the at least one protection device whereby the at least one light is energized so as to illuminate the unit when the at least one protection device operates.

### FIELD OF THE INVENTION

The present invention relates to consumer units which are installed in use in electrical supplies to domestic, commercial and industrial properties; moreover, the invention also relates to consumer units for use in vehicles and vessels, for example marine vessels.

### BACKGROUND TO THE INVENTION

In a typical electrical wiring installation, there are various electrical circuits, for example for controlling upstairs lighting, downstairs lighting, cooker points, immersion heaters and electrical sockets. Such electrical circuits are connected to an external power supply through a consumer unit.

The consumer unit comprises several current protection devices connected to their corresponding electrical circuits. Each protection device is operable in the event of an excess current flowing in its associated electrical circuit so as to interrupt connection from the external power supply to the electrical circuit.

The protection device may be a fuse which blows and which must be replaced to reconnect the external supply or a circuit breaker. The circuit breaker can be, for example, a magnetic circuit breaker (MCB) or a residual current device (RCD) which can be reset to reconnect the external supply.

In a U.S. Pat. No. 4,833,461, there is described a utility shut-off apparatus for shutting off utilities such as gas and electricity. The apparatus is arranged to function automatically in the case of an emergency such as an earthquake. The utilities can include one or more of gas and electricity. Moreover, at shut-down, an alarm may be sounded and a light activated. The apparatus includes a box mounted adjacent an associated main power panel. The box includes a solenoid wired to a breaker switch of the power panel and a start/stop switch coupled to a solenoid valve at the main gas line. If an earthquake hits, the solenoid to the electric panel is activated to shut off the main switch. Similarly, the solenoid to the gas line is activated to turn off the gas. Simultaneously, an acoustic signal alarm coupled to the box sounds and a light also coupled to the box is lit. The apparatus includes a rechargeable battery for powering the acoustic signal alarm and the light.

In order to detect earthquakes, the apparatus comprises a vibration and/or movement sensor.

In a Japanese patent no. JP11113110, there is described a distribution board including visual indicators for indicating failure of a lightning arrester therein. The board includes an emergency light apparatus.

The inventor has appreciated that a problem arises with consumer units in that they are often sited in dark and inconvenient locations, for example in cupboards, under staircases or in garages. If there is a failure in an electrical circuit which includes lighting for a corresponding location where a consumer unit is located, it is often extremely difficult for a user wishing to reset the consumer unit, to replace a fuse therein, to identify which fuse has blown therein and/or which circuit breaker has operated therein. The user must first try to locate a battery-operated torch and/or flashlight which in itself may be difficult if a lighting circuit has been disabled.

The inventor has devised an alternative type of consumer unit which is capable of addressing the aforesaid problem associated with conventional consumer units.

### SUMMARY OF THE INVENTION

According to a first aspect of the present invention, there is provided a consumer unit comprising at least one current protection device, characterised in that the unit further comprises at least one light associated with the unit, the at least one light being operatively connected to the at least one protection device whereby the at least one light is energised so as to illuminate the unit when the at least one protection device operates.

The consumer unit provides an advantage in that, should a fuse blow or a circuit breaker trip, the at least one light is capable of illuminating the unit so allowing the user to locate and then inspect the unit without first having to find a torch, flashlight or similar portable illumination device.

Preferably, the at least one light is operatively connected to all of the protection devices. Alternatively, preferably, the at least one light is operatively connected to just some of the protection devices in the unit. Most preferably, the at least one light is associated with a corresponding lighting circuit for a region wherein the consumer unit is situated. In some circumstances, it is necessary to connect the at least one light to other electrical circuits, since a room light or similar can still be switched on to illuminate the consumer unit.

The at least one light is preferably battery powered. More preferably, the battery is a rechargeable battery charged from mains power supplied to the consumer unit, thereby avoiding a need to replace batteries associated with the at least one light at regular intervals. Most preferably, the consumer unit comprises a trickle battery charger for charging the rechargeable battery.

Preferably, the rechargeable battery is a component capable of being trickle charged for long periods without exhibiting any “memory effects” or diminution of charge storage capacity therein. More preferably, the rechargeable battery comprises at least one of a nickel-metal rechargeable battery and a lithium rechargeable battery.

Preferably, the at least one light may be provided at any suitable location relative to the consumer unit. For example, the at least one light may be arranged at a top region of the unit, at a side region of the unit, at a bottom region of the unit and/or various combinations of such locations.

Preferably, the at least one light is formed integrally with the consumer unit. Alternatively, or additionally, the at least one light is mounted to the consumer unit.

Preferably when the electrical circuit with which the light is associated is de-energized by its corresponding protection device, the at least one light may be energized by way of any suitable device and/or mechanism. For example, the consumer unit preferably comprises a relay which in normal operation of the electrical circuit maintains a light switch associated with the at least one light in an open condition; when the electrical circuit is de-energized, the relay operates to close the switch thereby energizing the at least one light.

Preferably, switching means are provided to energize the at least one light in an event that a cover of the consumer unit is removed or lifted for maintenance or inspection purposes. More preferably, a switch arrangement similar to that used in a domestic refrigerator is most suitable for providing the switching means.

Preferably, the at least one light is arranged to operate in an intermittent flashing mode when energized in order to preserve battery charge and also help a user locate the consumer unit. Additionally, or alternatively, the consumer unit also includes an intermittently-bleeping acoustic sounder to assist the user locate the consumer unit in an event of one or more of the electrical circuits being isolated from the mains supply by way of the consumer unit.

Preferably, the consumer unit additionally includes a test facility for allowing for it to be periodically tested, for example to verify that the battery is charged, that the at least one light is functional and/or to check that an acoustic sounding device associated with the unit is functional to emit acoustic radiation.

Preferably, the consumer unit, or at least a part thereof, for example lettering associated with the protection devices, can be fluorescent so as to improve visibility.

Preferably, the at least one light overhangs the consumer unit to improve illumination thereof.

It will be appreciated that features of the consumer unit can be combined in any combination without departing from the scope of the invention.

### DESCRIPTION OF THE DIAGRAMS

Embodiments of the invention will now be described, by way of example only, with reference to the following diagrams wherein:

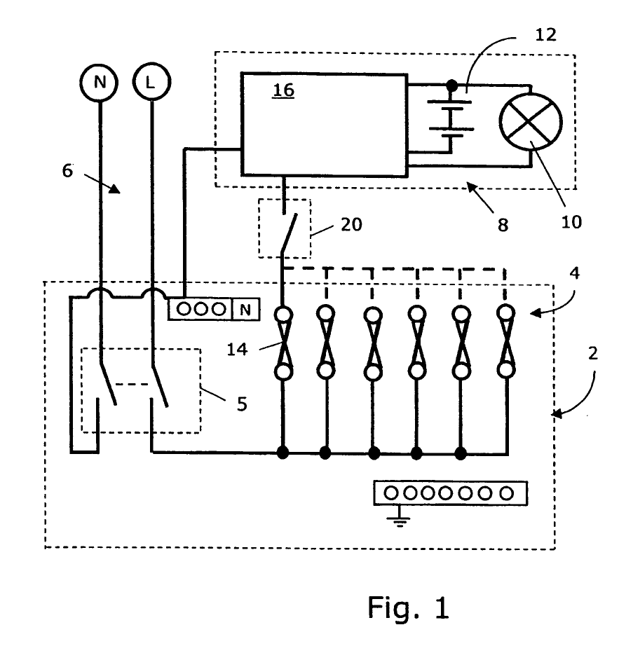

FIG. 1 is a schematic circuit diagram of a consumer unit according to the invention;

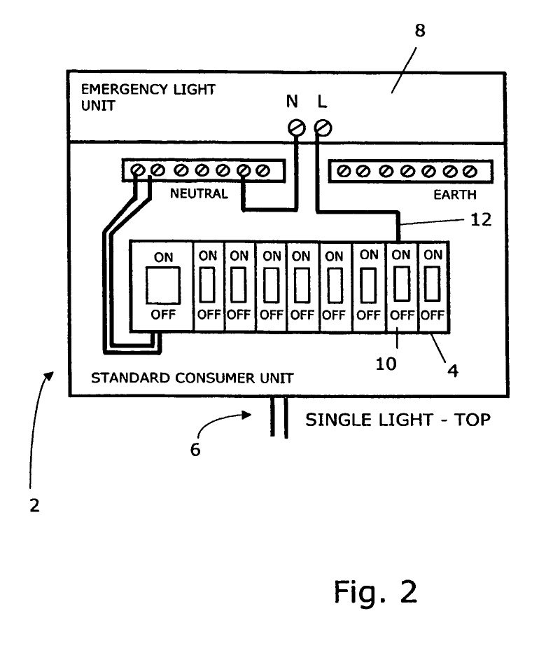

FIG. 2 is an illustration of a first embodiment of the invention;

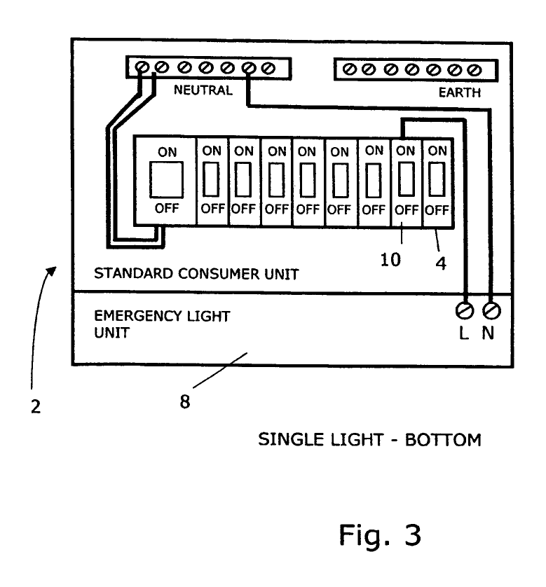

FIG. 3 is an illustration of a second embodiment of the invention;

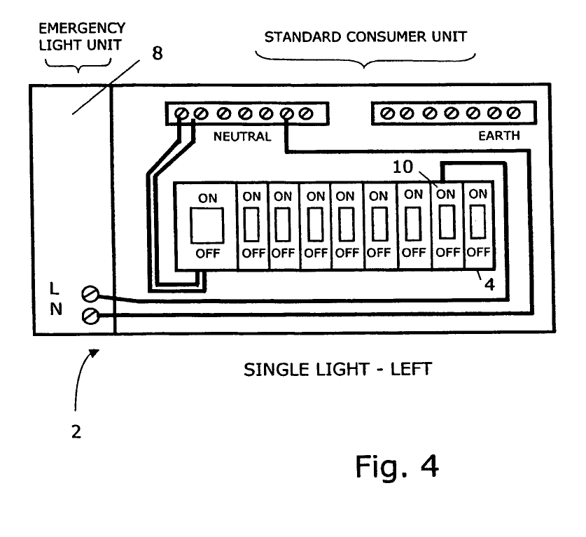

FIG. 4 is an illustration of a third embodiment of the invention; and

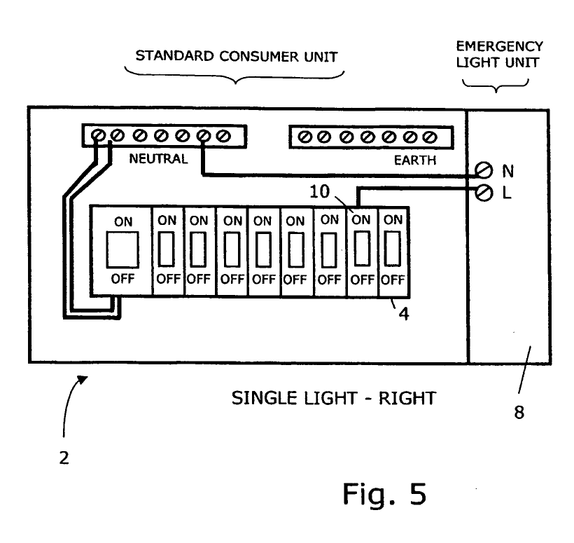

FIG. 5 is an illustration of a fourth embodiment of the invention.

### DESCRIPTION OF EMBODIMENTS OF THE INVENTION

Referring firstly to FIG. 1, there is shown an electrical consumer unit 2 comprising a bank of circuit breakers 4 associated with corresponding electrical circuits within a property, vehicle or vessel. Power is conducted from a mains power inlet 6 to the unit 2 and via its mains switch 5 and its circuit breakers 4 to the electrical circuits.

Associated with the consumer unit 2 is an emergency light unit 8. The light unit 8 is optionally integrated with the consumer unit 2; alternatively, the light unit 8 may be a separate item which is mounted adjacent the consumer unit 2, for example retrofitted thereto.

The light unit 8 includes a lamp 10, a battery 12 and a control unit 16. The battery 12 is optionally a disposable component which is discarded once exhausted. Alternatively, the battery 12 is a rechargeable device susceptible to being trickle charged from the mains supply. The rechargeable device is preferably one or more of a sealed lead acid battery, a nickel-cadmium battery, a nickel-metal battery and a lithium battery. The nickel-metal battery is especially preferred as it is less susceptible to exhibiting a “memory-effect” than nickel-cadmium batteries and is also less susceptible to sulphating problems associated with sealed lead-acid batteries.

The lamp 10 is connected to a circuit breaker 14 via the control unit 16. The circuit breaker 14 is that which is associated with the electrical lighting circuit for the part of the property, vehicle or vessel in which the consumer unit 2 is located or to be located.

The control unit 16 optionally includes charging circuits for trickle charging the battery 12. The control unit 16 also includes switching circuits which, when the circuit breaker 14 trips to interrupt the electrical supply to the lighting circuit of the property, vessel or vehicle, causes the lamp 10 to be illuminated so allowing a user to locate the consumer unit 2 and reset the circuit breaker 14.

Typically, at least one of the charging circuits and the switching circuits will include a relay or other device which, when the circuit breaker 14 is in circuit for conducting electrical current therethrough, maintains the lamp 10/battery 12 circuit open, but closes the circuit when the circuit breaker trips out. Moreover, it will be apparent that the lamp 10 will also be illuminated in an event of a mains surge causing all the circuit breakers 4 to operate to isolate their respective electrical circuits from the mains power inlet 6.

For testing purposes, or to illuminate the consumer unit 2 during maintenance, a further switch 20 is optionally included susceptible to causing the lamp 10 to be illuminated when the switch 20 is pressed.

Embodiments of the invention illustrated in FIGS. 2 to 5 include the light unit 8 in various positions. For example, in FIG. 2, the light unit 8 is positioned on top of the consumer unit 2. In FIG. 3, the light unit 8 is disposed below the consumer unit 2. Conversely, in FIGS. 4 and 5, the light unit 8 is positioned to the left and to the right of the consumer unit 2 respectively.

It will be appreciated that more than one light unit 8 can be provided. For example, several light units 8 may be provided in any combination of positions as shown in FIGS. 2 to 5; in one such example, light units 8 are provided substantially completely around a peripheral region of the consumer unit 2.

The light unit 8 may be integral with or separate from, for example mounted to, the consumer unit 2. More preferably, the consumer unit 2 is provided with slot-type or similar types of mechanical features with associated electrical connectors so that a user of the consumer unit 2 is capable of moving the light units 8 to preferred positions around the consumer unit 2, for example in response to personal taste or in response to physical positioning of the mains power inlet 6 and/or wiring from the unit 2 to the one or more electrical circuits.

One or more of the light units 8 preferably overhang the consumer unit 2 so that the lamp 10 is arranged in front of the consumer unit 2 to improve illumination thereof.

Preferably, when the consumer unit 2/light unit 8 are purchased, a circuit breaker 14 to which the light unit 8 is connected is highlighted so that a person installing may connect the electrical lighting circuit appropriate for the consumer unit 2 location to that circuit breaker 14.

It will be appreciated that modifications can be made to embodiments of the invention described in the foregoing without departing from the invention.

For example, the light unit 8 can be configured to illuminate when any one or more of the circuit breakers 4 are activated to isolate their respective circuits.

The light unit 8 can further include an acoustic sounder, for example a piezo-electric bleeper or small solid-state electronic siren, so that the consumer unit 2 emits an audible alarm when one or more of the circuit breakers 4 are activated.

The control unit 16 can be arranged to flash the lamp 10 in order to render it more noticeable in an event of one or more of the breakers 14 being activated; such flashing operation is of advantage in that it conserves charge in the battery 12. Alternatively, such a flashing operation can be used to enable a relatively lower capacity battery to be employed, thereby rendering the consumer unit 2 less expensive to manufacture. In a similar manner, the acoustic sounder can be switched to sound intermittently, thereby making its sound more distinctive to a user of the consumer unit 2.

It will be appreciated that the lamp 10 can be implemented in several different ways. For example, it can be a conventional incandescent heated filament bulb. Alternatively, it can be a compact fluorescent tube with associated high-tension excitation circuitry. Yet alternatively, it can be one or more high-efficiency light emitting diode (LED) modules, for example substantially white high-quantum efficiency LEDs.

In many installations, the consumer unit 2 will be located in a cupboard whose door is usually maintained closed for visual tidiness. As a consequence, when one or more circuit breakers 14 operate, the light unit 8 is energized and the consumer unit 2 is then only visible to a user by way of light leakage from the light unit 8 around a peripheral region of such a cupboard door when it abuts onto its associated cupboard frame. Whereas in most situations such light leakage enables a user to find the consumer unit 8, potential problems arise when the cupboard door is a near-perfect light seal. In such situations, the consumer unit 2 is provided with a connector socket so that an external lamp provided with a thin flying lead and associated plug can be optionally connected to the socket of the consumer unit 2, the external lamp susceptible to being mounted outside the cupboard in which the consumer unit 2 is located but sufficiently small not to appear aesthetically obtrusive, and the lead being sufficiently small in diameter not to prevent the cupboard door from being closed to conceal the consumer unit 2.

The consumer unit 2 can additionally be provided with a socket region for accommodating a pluggable version of an electricity meter, for example as manufactured by Invensys Inc. and/or Siemens GmbH; such an unpluggable meter is described in an international PCT patent application no. PCT/GB02/01493 which is hereby incorporated by reference. The unit 2 is thereby also capable of providing electricity consumption monitoring and hence making installation of electrical facilities into new premises or premises to be rewired considerably easier and cheaper. Optionally, the electricity meter can be an integral part of the consumer unit 2 and not implemented as an unpluggable component.

1-20. (canceled)

21. A consumer unit comprising at least one current protection device wherein the unit further comprises at least one light associated with the unit, said at least one light being operatively connected to said at least one protection device whereby said at least one light is energized so as to illuminate the unit when said at least one protection device operates, such that said at least one light is arranged to be sufficiently bright to enable a user of the unit to find the unit at least by way of peripheral stray radiation derived from said at least one light when said at least one protection device operates.

22. A unit as claimed in claim 21, wherein said at least one light is operatively connected to all of the protection devices.

23. A unit as claimed in claim 21, wherein at least one light is operatively connected to just some of the protection devices of the unit.

24. A unit as claimed in claim 21, wherein said at least one light is associated with a corresponding electrical lighting circuit for a region wherein the consumer unit is situated.

25. A unit as claimed in claim 21, wherein said at least one light is battery powered.

26. A unit as claimed in claim 25, wherein the battery is a rechargeable battery charged from main power applied to the consumer unit.

27. A unit as claimed in claim 26, further comprising a trickle battery charger for charging the rechargeable battery.

28. A unit as claimed in claim 26, wherein the rechargeable battery is substantially immune to discharge memory effects.

29. A unit as claimed in claim 28, wherein the rechargeable battery is one or more of a nickel-metal rechargeable battery and a lithium rechargeable battery.

30. A unit according to claim 21, wherein the at least one light is included in one or more of the following locations relative to the unit: a top region of the unit, a side region of the unit, a bottom region of the unit and substantially completely surrounding the unit at a peripheral region thereof.

31. A unit according to claim 21, wherein the at least one light is formed integrally with the consumer unit.

32. A unit according to claim 21, wherein the at least one light is mounted to the consumer unit.

33. A unit according to claim 21, wherein in operation, when the electrical circuit with which the at least one light is associated is de-energized by its corresponding protection device, the at least one light is energized by way of any suitable device and/or mechanism.

34. A unit according to claim 33, wherein the unit comprising a relay which:
in normal operation of the electrical circuit maintains a light switch associated with the at least one light in an open condition;
and when the electrical circuit is de-energized, operates to close the switch thereby energizing the at least one light.

35. A unit according to claim 21, wherein switch means is provided to energize the at least one light in an event of a cover of the consumer unit being removed or lifted for maintenance or inspection purposes.

36. A unit according to claim 35, wherein a switch arrangement similar to that used in a domestic refrigerator is used for providing the switch means.

37. A unit according to claim 21, wherein the at least one light is arranged to operate in an intermittent flashing mode when energized in order to preserve battery charge and also help a user locate the consumer unit.

38. A unit according to claim 21, wherein the consumer unit also includes an intermittently-bleeping acoustic sounder to assist the user locate the consumer unit in an event of one or more of the electrical circuits being isolated from the main supply by way of the consumer unit.

39. A unit according to claim 21, the unit further comprising a test facility for allowing the unit to be periodically tested for establishing at least one of:
to verify that the battery is charged;
the at least one light is functional; and
to check that an acoustic sounding device associated with the unit is functional to emit acoustic radiation.

40. A unit according to claim 21, wherein the at least one light overhangs the consumer unit to improve illumination thereof.
